(19) United States
(12) Patent Application Publication
(10) Pub. No.: US 2024/0089902 A1
(43) Pub. Date: Mar. 14, 2024

(54) METHOD FOR THE GEOLOCALIZATION OF A BASE STATION OF A WIRELESS COMMUNICATION SYSTEM

(71) Applicant: SIGFOX, LABEGE (FR)

(72) Inventors: Olivier ISSON, Lauzerville (FR); Renaud MARTY, RAMONVILLE SAINT AGNE (FR); Christophe JELOYAN, TOULOUSE (FR)

(21) Appl. No.: 17/767,854

(22) PCT Filed: Oct. 9, 2020
(86) PCT No.: PCT/EP2020/078363

§ 371 Date: Apr. 8, 2022

(30) Foreign Application Priority Data
Oct. 10, 2019 (FR) 1911222

(51) Int. Cl. H04W 64/00

(52) U.S. Cl. CPC H04W 64/003

(57) ABSTRACT

A method for the geolocalization of a base station, referred to as the “sought base station”, of an access network of a wireless communication system. The wireless communication system also includes at least one terminal capable of transmitting messages bound for the access network. A message transmitted by a terminal can be received simultaneously by a plurality of base stations of the access network. The geographical position of the sought base station is determined as a function of the geographical position of at least one other base station of the access network, referred to as the “reference base station.” The geographical position of the reference base station is known. The reference base station having received a message transmitted by the terminal that has likewise been received by the sought base station.

### FIELD OF THE INVENTION

The present invention lies in the field of geolocation. In particular, the invention relates to a method and a device for geolocation of a base station of an access network of a wireless communication system.

### BACKGROUND OF THE INVENTION

To operate an access network of a wireless communication system, it is important to know the geographic position of the various base stations that the access network includes.

Indeed, a base station is not necessarily permanently installed at a known geographic position that does not vary over time. In particular, a local base station can be installed in the home of a user or in a building of a business without the operator of the access network being informed thereof.

It may occur that certain functionalities of a base station must respect regulations that can vary from one country to another. In such a case, it should be known where a base station is positioned to be able to remotely configure such functionalities of the base station.

Moreover, the pricing of the exchanges of data carried out by a base station can vary according to the country in which the base station is located. Thus, the beneficiary of the costs of the exchanges of data carried out by a base station generally depends on the country in which the base station operates. It is therefore important to be able to determine the position of a base station over time when the base station can be moved.

It is of course possible to integrate into a base station a receiver of a satellite navigation system, such as GPS (Global Positioning System), in order to be able to determine in real time the position of the base station. However, such a solution increases the cost of the base station and is not always functional, in particular if the base station is positioned in a location in which the signals emitted by the satellites are not received.

While there are currently numerous solutions for determining the geographic position of a terminal of a wireless communication system, the issue of determining the geographic position of a base station is rarely addressed. Thus, there is currently still a need for a solution allowing to determine in real time and with sufficient precision the position of a base station of an access network of a wireless communication system.

### OBJECT AND SUMMARY OF THE INVENTION

The goal of the present invention is to overcome all or a part of the disadvantages of the prior art, in particular those disclosed above.

For this purpose, and according to a first aspect, the present invention proposes a method for geolocation of a base station, called “searched base station”, of an access network of a wireless communication system. Moreover, the wireless communication system comprises at least one terminal adapted to emit messages to said access network. A message emitted by a terminal can be received simultaneously by several base stations of the access network. The geographic position of the searched base station is determined according to the geographic position of at least one other base station of the access network, called “reference base station”. A reference base station is a base station, the geographic position of which is known and which has received a message emitted by said terminal also having been received by the searched base station.

It should be noted that it is not necessary for the position of the terminal to be known by the access network. Thus, the position of the searched base station can be determined without the latter needing to transmit information relative to its geographic position. No software or hardware modification of the base stations of the communication system is necessary to implement the geolocation method according to the invention. The geolocation method according to the invention can thus be implemented in a simply and not very costly manner.

In specific embodiments, the invention can further include one or more of the following features, taken alone or according to all the technically possible combinations.

In specific embodiments, the geographic position of the searched base station is further determined according to a measurement carried out for each reference base station of a value representative of a level of quality of a radio link between the terminal and said reference base station.

For a specific message emitted by a terminal and received both by a reference base station and by the searched base station, the radio link in question corresponds to the radio link established between the terminal and the reference base station for the transmission of this message.

In specific embodiments, the geographic position of the searched base station is a weighted average of the geographic positions of the reference base stations. Each geographic position of a reference base station is weighted by a coefficient, the value of which is representative of the level of quality of a radio link between the terminal and said reference base station.

In specific embodiments, the geographic position of the searched base station is further determined according to a measurement carried out for the searched base station of a value representative of a level of quality of a radio link between the terminal and the searched base station.

In specific embodiments, the geographic position of the searched base station is a weighted average of the geographic positions of the reference base stations. Each geographic position of a reference base station is weighted by a coefficient, the value of which is representative of the difference between the level of quality of a radio link between the terminal and the reference base station and the level of quality of a radio link between the terminal and the searched base station.

In specific embodiments, the geographic position of the searched base station is determined using a machine learning algorithm according to the measurements carried out and according to the geographic positions of the reference base stations.

In specific embodiments, a group of several messages is considered to determine the geographic position of the searched base station, each message of the group having been emitted by a terminal of the communication system and received by at least one reference base station and the searched base station. For each message, for the searched base station and for each of the reference base stations having received said message, a measurement of a value representative of a level of quality of a radio link between said base station and the terminal having emitted said message is carried out.

It is advantageous to consider several messages to determine the geographic position of the searched base station since this allows to reduce the bias and the estimation variance. The greater the number of messages considered, the better the precision of geolocation of the searched base station. The various messages considered can be emitted by a single terminal at various times, or by several different terminals.

In specific embodiments, the geographic position of the searched base station is determined according to a geographic position of the searched base station estimated for each message of the group.

In specific embodiments, a virtual measurement is calculated for each reference base station on the basis of the measurements carried out for said reference base station for the various messages received by said reference base station. The geographic position of the searched base station is thus determined according to the virtual measurements obtained and the geographic positions of the reference base stations.

In specific embodiments, the virtual measurement calculated for a reference base station is a weighted average of the measurements carried out for said reference base station for the various messages received by said reference base station. Each measurement is weighted by a coefficient, the value of which is representative of the measurement of the level of quality of a radio link carried out for the searched base station for the corresponding message.

In specific embodiments, the geographic position of the searched base station is a weighted average of the geographic positions of the reference base stations. Each geographic position of a reference base station is weighted by a coefficient, the value of which is representative of the virtual measurement calculated for said reference base station.

In specific embodiments, the geographic position of the searched base station is determined by a regression machine learning algorithm according to the measurements carried out and according to the geographic positions of the reference base stations.

According to a second aspect, the present invention relates to a computer program product comprising a set of program code instructions which, when they are executed by one or more processors, configure the processor(s) to implement a method for geolocation of a base station according to any one of the preceding embodiments.

According to a third aspect, the present invention relates to a server of a wireless communication system. The wireless communication system comprises a plurality of base stations and at least one terminal adapted to emit messages to said base stations. A message emitted by the terminal can be received simultaneously by several base stations. The server is connected by a communication link to each base station of the plurality of base stations. The server is configured to implement a method for geolocation of a base station according to any one of the preceding embodiments.

According to a fourth aspect, the present invention relates to an access network of a wireless communication system. The access network comprises a plurality of base stations and a server as described above.

### BRIEF DESCRIPTION OF THE DRAWINGS

The invention will be better understood upon reading the following description, given as an example that is in no way limiting, and made while referring to FIGS. 1 to 8 which show:

FIG. 1 is a diagram of a wireless communication system comprising at least one terminal and an access network comprising a plurality of base stations,

FIG. 2 is a diagram of the main steps of a method for geolocation of a base station according to the invention,

FIG. 3 is a diagram of the main steps of a first specific embodiment of a geolocation method according to the invention,

FIG. 4 is a diagram of the main steps of a second specific embodiment of a geolocation method according to the invention,

FIG. 5 is a diagram of the main steps of a third specific embodiment of a geolocation method according to the invention,

FIG. 6 is a diagram of the main steps of a fourth specific embodiment of a geolocation method according to the invention,

FIG. 7 is a diagram of the main steps of a fifth specific embodiment of a geolocation method according to the invention, and

FIG. 8 is a diagram of a model used by a machine learning algorithm implementing a geolocation method according to the invention.

In these drawings, references identical from one drawing to another designate identical or similar elements. For reasons of clarity, the elements shown are not necessarily on the same scale, unless otherwise mentioned.

### DETAILED DESCRIPTION OF AN EMBODIMENT OF THE INVENTION

The present invention has a particularly advantageous, although in no way limiting, use in the wireless communication systems of the Internet of Things (IoT) type or of the M2M (acronym for Machine to Machine) type.

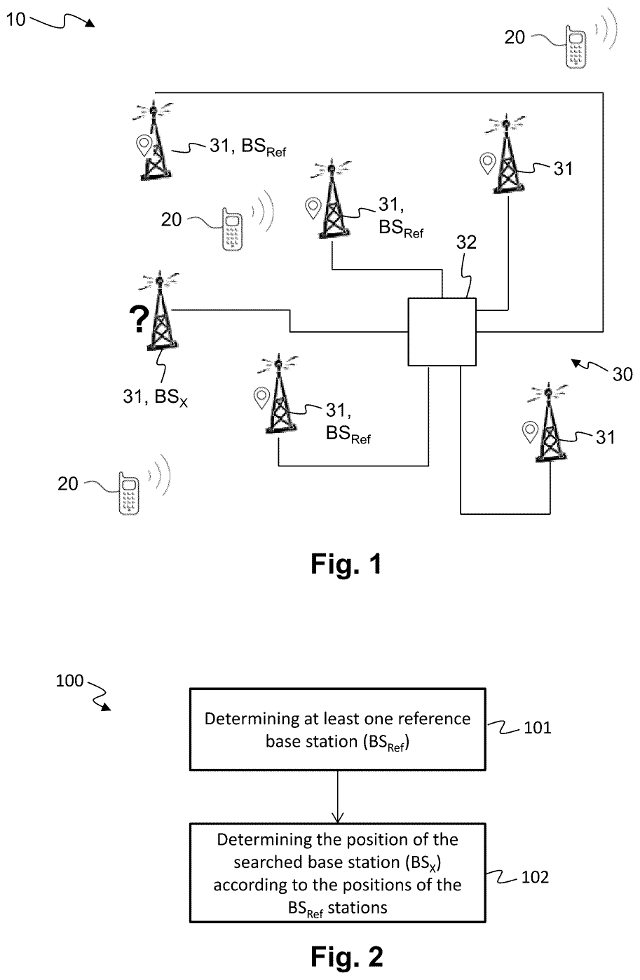

FIG. 1 schematically shows a wireless communication system 10, comprising one or more terminals 20 and an access network 30. The access network 30 comprises several base stations 31 and a server 32 connected to said base stations 31.

In such a wireless communication system 10, the exchanges of data are substantially unidirectional, in this case on an upstream link from the terminals 20 towards the access network 30 of said wireless communication system 10. In order to minimize the risks of losing a message emitted by a terminal 20, the planning of the access network 30 is often carried out in such a way that a given geographic zone is simultaneously covered by several base stations 31, in such a way that a message emitted by a terminal 20 can be received by several base stations 31. This means that the same message emitted by the terminal 20 can be received, decoded, and processed by several base stations 31 (and not only by a single base station with which the terminal is associated).

Each base station 31 is adapted to receive messages from the terminals 20 that are within its range. A message emitted by a terminal 20 includes in particular an identifier of the terminal allowing to identify said terminal 20. Each message thus received is for example transmitted to the server 32 of the access network 10, optionally accompanied by other information such as an identifier of the base station 31 that received it, a value representative of the quality of the radio signal carrying the message, the central frequency on which the message was received, a date on which the message was received, etc. The server 32 processes for example all of the messages received from the various base stations 31.

The wireless communication system 10 is for example a wide wireless network with low electricity consumption known by the term LPWAN (acronym for Low Power Wide Area Network). Such a wireless communication system is an access network with a long range (greater than one kilometer, or even greater than several tens of kilometers), with low energy consumption (for example an energy consumption during the transmission or the reception of a message of less than 100 mW, or even less than 50 mW, or even less than 25 mW), and the bitrates of which are generally lower than 1 Mbits/s. Such wireless communication systems are particularly adapted for uses involving smart objects.

In specific embodiments, the wireless communication system 10 can be an ultra-narrowband communication system. “Ultra-narrowband” (or UNB) means that the instantaneous frequency spectrum of the radio signals emitted by the terminals has a frequency width of less than two kilohertz, or even less than one kilohertz. Such a system allows to significantly limit the electricity consumption of the terminals when they communicate with the access network.

In the example considered and illustrated in FIG. 1, the geographic position of a particular base station 31 of the access network 30 is searched for. The searched base station carries the reference BS_{X}. One or more base stations 31 distinct from the searched base station BS_{X} correspond to reference base stations BS_{Ref}. A reference base station BS_{Ref} is a base station 31 of the access network 30, the geographic position of which is known and which received a message emitted by a terminal 20 also having been received by the searched base station BS_{X}.

The server 32 can in particular be used to implement all or part of a method for geolocation of the searched base station BS_{X}. For this purpose, the server 32 includes a processing circuit comprising one or more processors and memorization means (magnetic hard disk, solid-state memory, optical disk, etc.) in which a computer program product is memorized, in the form of a set of program code instructions to be executed to implement at least a part of the steps of a method for geolocation of a base station 31 of the access network 30 of the wireless communication system 10. Alternatively or in addition, the processing circuit of the server 32 includes one or more programmable logic circuits (FPGA, PLD, etc.), and/or one or more specialized integrated circuits (ASIC), and/or a set of discrete electronic components, etc. adapted to implement steps of the geolocation method. In other words, the server 32 includes software and/or hardware means for implementing a geolocation method according to the invention.

FIG. 2 schematically shows the main steps of a method 100 for geolocation of the searched base station BS_{X}.

The geolocation method 100 includes in particular a step 101 of determining at least one reference base stations BS_{Ref}, the geographic position of which is known and which received a message emitted by a terminal 20 also having been received by the searched base station BS_{X}. The server 32 can indeed determine, for a given message, which base stations 31 received this message. For this purpose, the message received includes for example an identifier of the terminal 20 which emitted the message as well as a sequence number allowing to identify this message, and a base station which receives the message transmits the message to the server accompanied by an identifier of the base station.

The method 100 then includes a step 102 of determining the geographic position of the searched base station BS_{X} according to the geographic position of each reference base station BS_{Ref} determined in step 101. For this purpose, it is supposed that the server has access to a database comprising the geographic positions of an entire set of base stations 31 which can thus act as reference base stations BS_{Ref}.

For example if a single reference base station BS_{Ref} is determined in step 101, the geographic position of the searched base station BS_{X} can be determined in step 102 as being the geographic position of said reference base station BS_{Ref}. In such a case, the precision of geolocation of the searched base station BS_{X} is relatively low since it has a geolocation error that can be up to two times the emission range of the terminal 20 having emitted the message.

According to another example, if several reference base stations BS_{Ref} are determined in step 101, the geographic position of the searched base station BS_{X} can be defined in step 102 as being an average of the geographic positions of the various reference base stations BS_{Ref} used.

It should be noted that “geographic position” means for example a system of two coordinates corresponding to the latitude and the longitude. An average geographic position calculated among several geographic positions would thus have as the latitude the average value of the latitudes of the various geographic positions and as the longitude the average value of the longitudes of the various geographic positions. Nothing prevents, however, a third coordinate corresponding to an altitude with respect to the sea level from also being considered.

To improve the precision of the geolocation of the searched base station BS_{X}, it is also possible to take into account a measurement of a value representative of a level of quality of a radio link established between a terminal 20 and a base station 31 of the access network 30.

In a preferred embodiment, and in the rest of the description, as an example that is in no way limiting, the value representative of the quality of a radio link used is a level of received power (Received Signal Strength Indicator or RSSI) measured for a base station 31 for a signal carrying a message emitted by a terminal 20. It should be noted, however, that other values representative of the quality of the radio link could be used, for example such as the attenuation of the signal, a signal-to-noise ratio of the signal (or SNR) or an indicator of quality of the communication channel (Channel Quality Indicator or CQI). The choice of a particular value representative of the quality of a radio link merely constitutes an alternative of the invention. It should also be noted that the measurement can be carried out either directly by the base station that received the message, or indirectly by the server 32 on the basis of information provided by the base station that received the message.

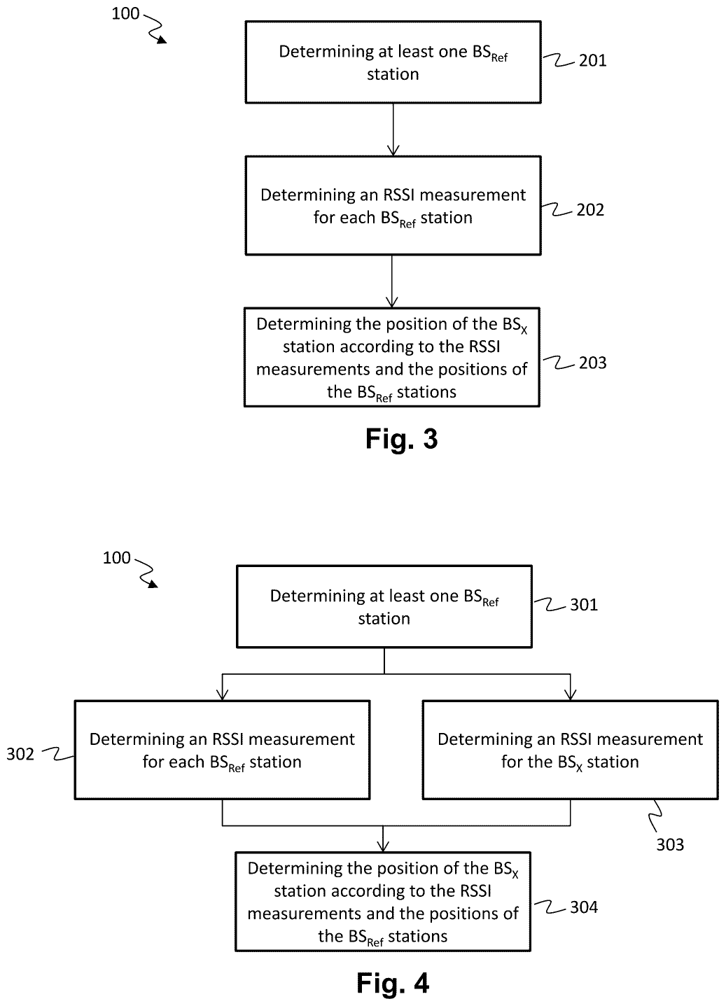

FIG. 3 schematically shows the main steps of a first specific embodiment of the geolocation method 100 according to the invention. In this first specific embodiment, a single message received both by the searched base station BS_{X} and by at least one reference base station BS_{Ref} is considered. An RSSI measurement of the level of power with which the message is received is thus carried out for each reference base station BS_{Ref} used.

Step 201 is identical to step 101 described above in reference to FIG. 2.

In step 202, an RSSI value is measured for each reference base station BS_{Ref} determined in step 201 for the message considered.

In step 203, the geographic position of the searched base station BS_{X} is determined not only according to the geographic position of each reference base station BS_{Ref} determined in step 201, but also according to the RSSI values measured in step 202 for these reference base stations BS_{Ref}.

For example, the geographic position of the searched base station BS_{X} is determined as being a weighted average of the geographic positions of the reference base stations BS_{Ref}, each geographic position of a reference base station BS_{Ref} being weighted by a coefficient, the value of which is representative of the level of quality of the radio link (that is to say the RSSI value in the example considered) established between the terminal 20 and said reference base station BS_{Ref} during the exchange of the message considered.

This can translate into the expression below (Equation 1):

$${Z}_{X} = {\sum }_{k = 1}^{K} {α}_{k} \cdot {Z}_{k}$$

in which:
K is the number of reference base stations BS_{Ref} used to determine the geographic position of the searched base station BS_{X},
Zₖ is the known geographic position of a reference base station BS_{Ref} having the index k,
αₖ is the weighting coefficient associated with the reference base station BS_{Ref} having the index k,
Z_{X} is the determined geographic position of the searched base station BS_{X} (in other words, X is the index of the searched base station).
   Each weighting coefficient αₖ is for example calculated according to the expression below (Equation 2):

$${α}_{k} = \frac{1 {0}^{- \frac{\vert rss {i}_{k} \vert}{γ}}}{{Σ}_{j = 1}^{K} 1 {0}^{- \frac{\vert rss {i}_{j} \vert}{γ}}}$$

in which:
rssiₖ is the measurement of the level of received power (RSSI measurement) carried out for the reference base station BS_{Ref} having the index k,
γ is a normalization factor, the value of which is constant. It should be noted that the same symbol γ is used below in various mathematical expressions to represent a normalization factor. The value of the normalization factor, however, can vary from one expression to the other.

In the examples considered in the present application, the RSSI measurement is expressed in dBm (power ratio in decibels between the measured power and a milliwatt). The RSSI measurement is a negative value. The greater the absolute value of the RSSI measurement, the lower the level of received power measured. Inversely, the smaller the absolute value of the RSSI measurement, the higher the level of received power measured.

Such arrangements allow to determine the geographic position of the searched base station BS_{X} according to the geographic positions of the reference base stations BS_{Ref} while favoring the reference base stations BS_{Ref} for which the message considered was received with a high RSSI level. In other words, to determine the geographic position of the searched base station BS_{X}, greater confidence is granted to the reference base stations BS_{Ref} that received the message considered with a high RSSI level.

It should be noted that other factors could be taken into consideration to determine weighting coefficients respectively for the various reference base stations BS_{Ref}. For example, it is possible to consider the environment in which the reference base station is located (urban, mountainous, maritime area), or the altitude at which the reference base station is located.

FIG. 4 schematically shows the main steps of a second specific embodiment of the geolocation method 100 according to the invention. This second specific embodiment comprises in particular a step 301 of determining at least one reference base station BS_{Ref} and a step 302 of determining an RSSI measurement for each reference base station BS_{Ref} identified. Steps 301 and 302 are respectively identical to steps 201 and 202 of the first specific embodiment described above in reference to FIG. 3. Moreover, this second specific embodiment includes a step 303 of determining an RSSI measurement of the level of power with which the message considered is received by the searched base station BS_{X}. In a step 304, the geographic position of the searched base station BS_{X} is thus determined according to the RSSI measurements carried out not only for the reference base stations BS_{Ref}, but also for the searched base station BS_{X}.

For example, the geographic position of the searched base station BS_{X} is a weighted average of the geographic positions of the reference base stations BS_{Ref}, in which each geographic position of a reference base station is weighted by a coefficient, the value of which is representative of the difference between the RSSI level measured for said reference base station BS_{Ref} and the RSSI level measured for the searched base station BS_{X}.

In other words, the geographic position Z_{X} of the searched base station BS_{X} can be determined according to the Equation 1 by using weighting coefficients αₖ defined by the expression below (Equation 3):

$${α}_{k} = \frac{1 {0}^{- \frac{\vert rss {i}_{X} - {rssi}_{k} \vert}{γ}}}{{Σ}_{j = 1}^{K} 1 {0}^{- \frac{\vert rss {i}_{X} - {rssi}_{j} \vert}{γ}}}$$

in which:
rssiₖ is the measurement of the level of received power (RSSI measurement) carried out for the reference base station BS_{Ref} having the index k,
rssi_{X} is the measurement of the level of received power (RSSI measurement) carried out for the searched base station BS_{X}.

Such arrangements allow to determine the geographic position of the searched base station BS_{X} according to the geographic positions of the reference base stations BS_{Ref} while favoring the reference base stations for which the message considered was received with an RSSI level close to the RSSI level with which said message was received by the searched base station BS_{X}. In other words, to determine the geographic position of the searched base station BS_{X}, greater confidence is granted to the reference base stations BS_{Ref} that received the message with an RSSI level close to the RSSI level with which the message was received by the searched base station BS_{X}. In comparison to the first specific embodiment described in reference to FIG. 3, taking into account the RSSI level with which the message was received by the searched base station BS_{X} allows to improve the precision of the geolocation of the searched base station.

In specific embodiments, it is also possible to determine the geographic position of the searched base station BS_{X} using a machine learning algorithm based on a model preestablished on the basis of measurements of RSSI level or differences in RSSI level. The model is for example constructed during a learning phase by associating known geographic positions with values of weighting coefficients such as those described by Equation 2 and Equation 3. The machine learning algorithm is configured to determine, during a search phase, a geographic position of a searched base station on the basis of the model thus constructed and on the basis of values of weighting coefficients calculated for reference base stations having received a particular message which was also received by the searched base station.

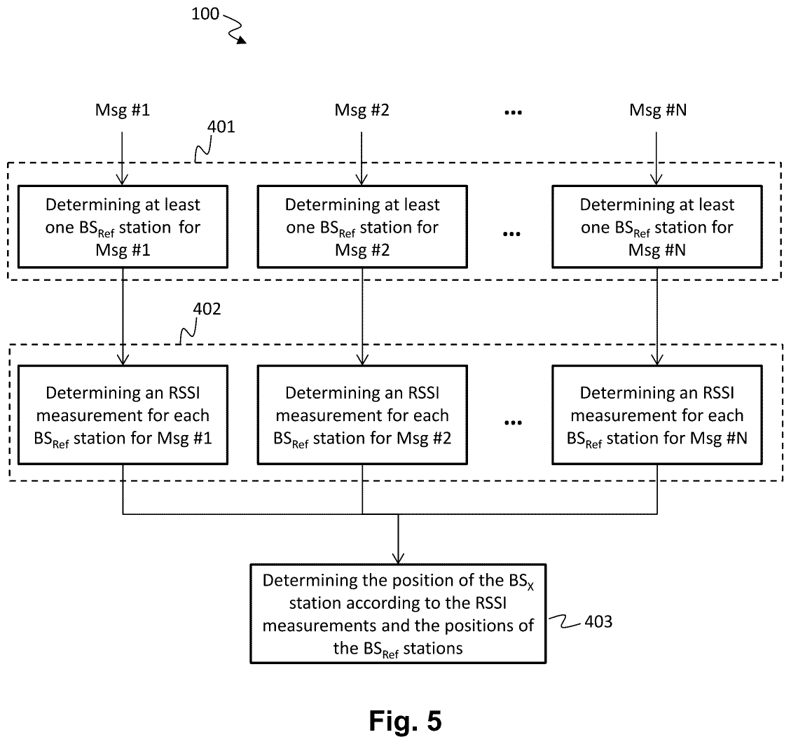

FIG. 5 schematically shows the main steps of a third specific embodiment of the geolocation method 100 according to the invention. In this third specific embodiment, a group of several messages (Msg #1, Msg #2, . . . Msg #N) is considered to determine the geographic position of the searched base station BS_{X}. Each message considered was emitted by a terminal 20 of the wireless communication system 10 and received both by at least one reference base station BS_{Ref} and by the searched base station BS_{X}. It should be noted that the various messages considered can have been emitted by the same terminal 20 or by several different terminals 20. Thus, the various messages considered can have been emitted substantially at the same time or at different times during a predetermined period of time.

As illustrated in FIG. 5, in this third specific embodiment, for each message considered, there is thus a determination of at least one reference base station BS_{Ref} that received said message considered (step 401). This determination of at least one reference base station BS_{Ref} for a particular message is identical to the steps 201 and 301 described above respectively for the first and for the second specific embodiment in reference to FIGS. 3 and 4. Thus, for each message considered, an RSSI measurement of the level of power with which said message was received is carried out for each of the reference base stations BS_{Ref} having received said message (step 402). This determination of an RSSI measurement for each reference base station BS_{Ref} for a particular message is identical to the steps 202 and 302 described above respectively for the first and for the second specific embodiment in reference to FIGS. 3 and 4.

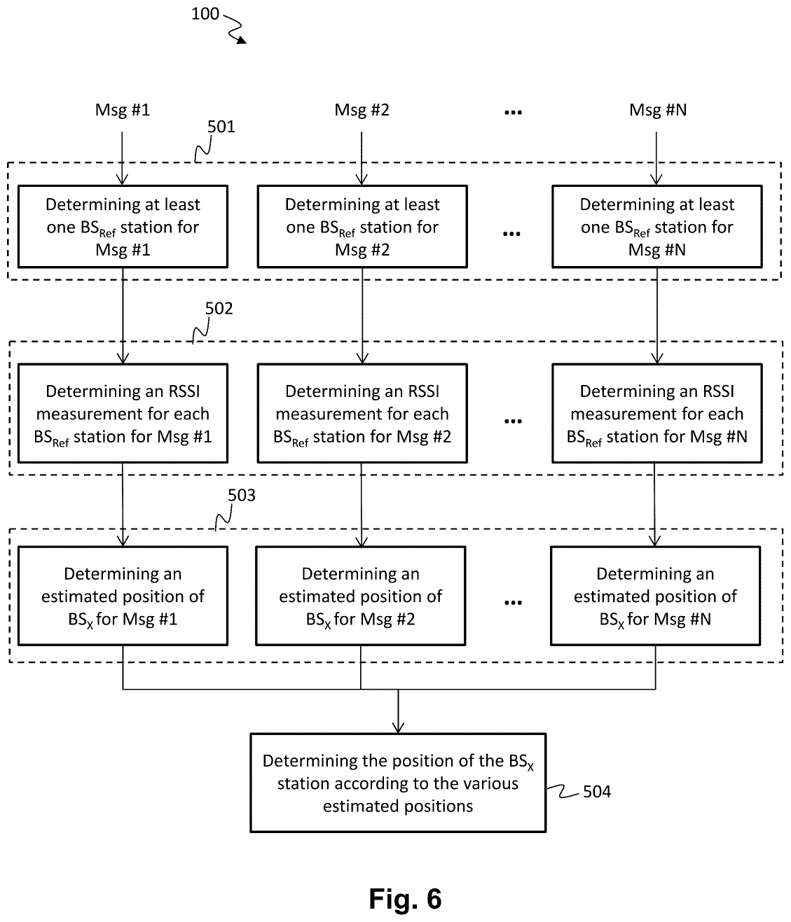

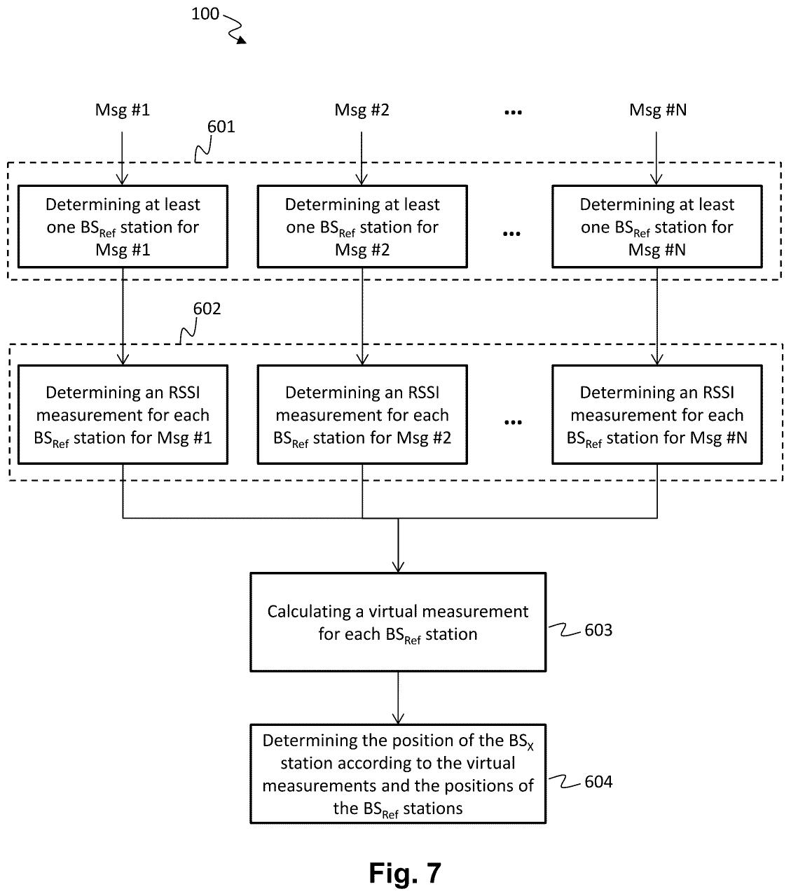

As will be described in reference to FIGS. 6 and 7, various methods are thus possible to determine, in a step 403, the geographic position of the searched base station BS_{X} according to the RSSI measurements carried out and according to the known geographic positions of the reference base stations BS_{Ref}.

In comparison to the first and the second specific embodiment, it is advantageous to consider several messages to determine the geographic position of the searched base station BS_{X} since this allows to reduce the bias and the estimation variance. The greater the number of messages considered, the better the precision of geolocation of the searched base station BS_{X}.

FIG. 6 schematically shows the main steps of a fourth specific embodiment of the geolocation method 100 according to the invention. This fourth specific embodiment is based on the third specific embodiment described above in reference to FIG. 5. In particular, the step 501 of determining, for each message considered, at least one reference base station, and the step 502 of determining, for each message considered, an RSSI measurement for each reference base station having received said message are identical respectively to the steps 401 and 402 of the third specific embodiment described in reference to FIG. 5.

This fourth specific embodiment further includes a step 503 in which, for each message considered, an estimated geographic position of the searched base station is determined, as well as a step 504 in which the geographic position of the searched base station is determined according to the various positions estimated in step 503.

In step 503, for a message considered, the estimated geographic position of the searched base station can be determined as being the average of the geographic positions of the reference base stations BS_{Ref} having received said message. To improve the precision of geolocation, this average can be weighted according to weighting coefficients, the values of which are representative of the RSSI measurements measured for the reference base stations having received said message.

In other words, for a message having the index m out of the set of messages considered, the estimated geographic position Z_{m,X} of the searched base station BS_{X} can be defined by the expression below (Equation 4):

$${Z}_{m , X} = {\sum }_{k = 1}^{{K}_{m}} {α}_{m , k} \cdot {Z}_{k}$$

in which:
Kₘ is the number of reference base stations BS_{Ref} having received the message having the index m,
Zₖ is the known geographic position of a reference base station having the index k,
α_{m,k} is the weighting coefficient associated with the reference base station having the index k.

For example, the weighting coefficient α_{m,k} can be defined according to the expression below (Equation 5):

$${α}_{m , k} = \frac{1 {0}^{- \frac{\vert rss {i}_{m , k} \vert}{γ}}}{{Σ}_{i = 1}^{{K}_{m}} 1 {0}^{- \frac{\vert rss {i}_{m , i} \vert}{γ}}}$$

in which rssi_{m,k} is the measurement of the level of received power (RSSI measurement) for the reference base station BS_{Ref} having the index k for the message having the index m, and γ is a constant normalization value.

Such arrangements allow, during the calculation of the estimated geographic position of the searched base station BS_{X} on the basis of the message having the index m, to give greater importance to the reference base stations BS_{Ref} having received this message having the index m with a high RSSI level.

In step 504, the geographic position Z_{X} of the searched base station BS_{X} can for example be defined as a simple average of the geographic positions thus estimated (expressed as Equation 6):

$${Z}_{X} = \frac{1}{M} \cdot {\sum }_{m = 1}^{M} {Z}_{m , X}$$

In the above expression, M corresponds to the total number of messages considered.

Advantageously, it is also possible to weight this average with weighting coefficients, the values of which are representative of the RSSI levels with which the searched base station BS_{X} received the message having the index m (expressed as Equation 7):

$${Z}_{X} = {\sum }_{m = 1}^{M} \frac{1 {0}^{- \frac{\vert rss {i}_{m , X} \vert}{γ}}}{{Σ}_{n = 1}^{M} 1 {0}^{- \frac{\vert rss {i}_{n , X} \vert}{γ}}} \cdot {Z}_{m , X}$$

Such arrangements allow, during the calculation of the geographic position of the searched base station BS_{X}, to give more importance to the messages that were received by the searched base station with a high RSSI level. Here again, this allows to improve the precision of geolocation.

As already mentioned for the embodiments described above, the estimation carried out for a particular message in step 503 of the geographic position of the searched base station BS_{X} and/or the final determination in step 504 of the geographic position of the searched base station BS_{X} could also be carried out using a machine learning algorithm, for example an algorithm of the data clustering type. Also, weighting factors other than the RSSI measurement could be taken into consideration to determine weighting coefficients for the various reference base stations BS_{Ref}.

FIG. 7 schematically shows the main steps of a fifth specific embodiment of the geolocation method 100 according to the invention. This fifth specific embodiment is based on the third specific embodiment described above in reference to FIG. 5. In particular, the step 601 of determining, for each message considered, at least one reference base station BS_{Ref}, and the step 602 of determining, for each message considered, an RSSI measurement for each reference base station BS_{Ref} having received said message, are respectively identical to the steps 401 and 402 of the third specific embodiment described in reference to FIG. 5.

This fifth specific embodiment further includes a step 603 in which a virtual measurement is calculated for each reference base station BS_{Ref} on the basis of the RSSI measurements carried out for said reference base station for the various messages received by said reference base station.

For example, the virtual measurement calculated for a reference base station BS_{Ref} can correspond to a simple average of the RSSI measurements carried out for said reference base station for the various messages received by said reference base station, which can translate into the expression below (Equation 8):

$$V r s s {i}_{k} = \frac{1}{{M}_{k}} \cdot {\sum }_{m = 1}^{{M}_{k}} r s s {i}_{m , k}$$

in which:
Vrssiₖ is the virtual measurement calculated for a reference base station BS_{Ref} having the index k,
Mₖ is the number of messages received by this reference base station having the index k out of the set of messages considered,
rssi_{m,k} is the RSSI measurement carried out for the reference base station having the index k for a message having the index m chosen from the Mₖ messages received.

To improve the precision of geolocation, the virtual measurement calculated for a reference base station BS_{Ref} can correspond to a weighted average of the RSSI measurements carried out for said reference base station for the various messages received by said reference base station. Each RSSI measurement is for example weighted by a coefficient, the value of which is representative of the RSSI measurement carried out for the searched base station BS_{X} for the corresponding message. This can translate into the expression below (Equation 9):

$$V r s s {i}_{k} = {\sum }_{m = 1}^{{M}_{k}} \frac{1 {0}^{- \frac{\vert rss {i}_{m , X} \vert}{γ}}}{{Σ}_{n = 1}^{{M}_{k}} 1 {0}^{- \frac{\vert rss {i}_{n , X} \vert}{γ}}} \cdot {rssi}_{m , k}$$

in which rssi_{m,X} is the RSSI measurement carried out for the searched base station BS_{X} for a message having the index m chosen from the Mₖ messages that were received both by the reference base station BS_{Ref} having the index k and by the searched base station BS_{X}.

In step 604, the geographic position of the searched base station BS_{X} is determined according to the virtual measurements thus obtained and according to the geographic positions of the reference base stations BS_{Ref}.

The geographic position Z_{X} of the searched base station BS_{X} can for example be defined as a weighted average of the geographic positions Zₖ of the K reference base stations BS_{Ref}.

For example, each geographic position of a reference base station is weighted by a weighting coefficient representative of the virtual measurement calculated for said reference base station (expressed as Equation 10):

$${Z}_{X} = {\sum }_{k = 1}^{K} \frac{1 {0}^{- \frac{\vert {Vrssi}_{k} \vert}{γ}}}{{Σ}_{i = 1}^{K} 1 {0}^{- \frac{\vert {Vrssi}_{i} \vert}{γ}}} \cdot {Z}_{k}$$

According to another example, each geographic position of a reference base station BS_{Ref} is weighted by a weighting coefficient representative of the difference between the virtual measurement calculated for said reference base station and the virtual measurement calculated for the searched base station BS_{X} (expressed as Equation 11):

$${Z}_{X} = {\sum }_{k = 1}^{K} \frac{1 {0}^{- \frac{\vert {Vrssi}_{X} - {Vrssi}_{k} \vert}{γ}}}{{Σ}_{i = 1}^{K} 1 {0}^{- \frac{\vert {Vrssi}_{X} - {Vrssi}_{i} \vert}{γ}}} \cdot {Z}_{k}$$

In the above expression, Vrssi_{X} corresponds to the virtual measurement calculated for the searched base station BS_{X}, which can for example correspond to the average of the RSSI levels measured for the searched base station BS_{X} for the M various messages considered (expressed as Equation 12):

$$V r s s {i}_{X} = \frac{1}{M} \cdot {\sum }_{m = 1}^{M} r s s {i}_{m , X}$$

In specific embodiments, the geographic position of the searched base station BS_{X} is determined by a regression machine learning algorithm according to the measurements carried out and according to the geographic positions of the reference base stations BS_{Ref}.

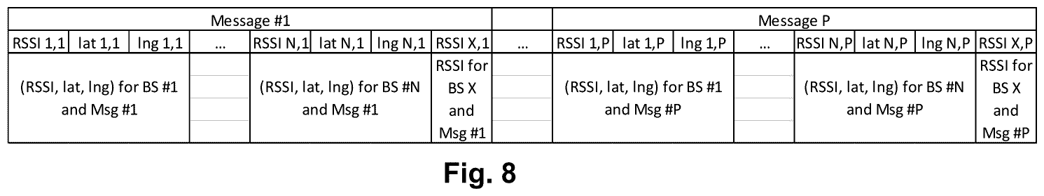

FIG. 8 shows an example of a model used by the machine learning algorithm. The model corresponds to a matrix of characteristics memorized in a database accessible to the server 32.

The machine learning algorithm is configured to generate a regression function allowing to determine the geographic position (longitude, latitude) of a base station on the basis of this matrix of characteristics.

Each line of the matrix corresponds to a searched base station BS_{X} of the access network 30. To determine the geographic position of the searched base station BS_{X}, the following are considered:
a group of P messages received by the searched base station BS_{X},
for each message, a selection of N reference base stations BS_{Ref} having the highest RSSI values measured for said message,
the P RSSI measurements carried out for the searched base station BS_{X} for the P messages considered.

Thus, the 3N first columns of the matrix of characteristics respectively correspond to the RSSI measurement, the longitude and the latitude of N reference base stations BS_{Ref} having the highest values of RSSI measurement for a first message received both by the searched base station BS_{X} and by each of the reference base stations. The column (3N+1) corresponds to the RSSI measurement for the searched base station BS_{X} for this first message. The columns (3N+2) to (6N+2) correspond to similar values for a second particular message. The columns ((P−1)(3N+1)+1) to P(3N+1) correspond to similar values for a P^{th} particular message. It should be noted that if certain values of the matrix of characteristics are not available (for example if there are less than N reference base stations identified for a given message) default values can be used. Also, other characteristics specific to each base station can be added into the matrix of characteristics, for example the altitude of the reference base station, or the environment in which it is located (urban, mountainous, maritime, etc. area).

To train the model and learn the regression function, it is considered that the base stations to be geolocated correspond to base stations, the geographic position of which is known.

It is possible to create several lines of the matrix of characteristics for the same base station. For example, the P messages of the same line correspond to messages received consecutively (optionally coming from various terminals) during a certain period of time, and various lines associated with the same base station correspond to various periods of time (and thus to various sequences of messages received during said periods of time). According to another example, the P messages of the same line correspond to messages emitted consecutively by the same single terminal during a certain period of time, and various lines associated with the same base station correspond to various terminals (and optionally to various periods of time also).

Once the regression function is learned, it can be used to predict the geographic position of a searched base station BS_{X} on the basis on the one hand of the model memorized in the database and on the other hand on the basis of the RSSI measurements carried out for a group of messages.

Various types of regression machine learning algorithms can be used, for example such as algorithms of the random forest type or of the gradient boosting type.

In the example illustrated in FIG. 8, a selection of N reference base stations BS_{Ref} having the highest measured RSSI values is carried out for each message considered. It should be noted, however, that it is possible to carry out a selection of N reference base stations or of P messages according to various criteria. For example, the P messages and the N base stations could be selected to maximize the number of common base stations having received the P messages. According to another, the P messages and the N base stations could be selected to maximize the spatial diversity of the base stations.

The above description clearly illustrates that, via its various features and their advantages, the present invention achieves the goals set. In particular, the invention allows to geolocate a base station of an access network of a wireless communication system in a simple and not very costly manner, without it being necessary to modify the base stations of the system in terms of software and/or hardware.

1-15. (canceled)

16. A method for geolocation of a base station referred to as a searched base station of an access network of a wireless communication system, the wireless communication system comprising at least one terminal configured to emit messages to the access network, a message emitted by said at least one terminal being configured to be received simultaneously by several base stations of the access network, a geographic position of the searched base station being determined according to a geographic position of at least one other base station of the access network referred to as at least one reference base station of the access network; wherein the geographic position of said at least one reference base station is known; and wherein the message emitted by said at least one terminal is received by said at least one reference base station and the searched based station.

17. The geolocation method of claim 14, wherein the geographic position of the searched base station is further determined according to a measurement carried out for each reference base station of a value representative of a level of quality of a radio link between said at least one terminal and said each reference base station.

18. The geolocation method of claim 17, wherein the geographic position of the searched base station is a weighted average of geographic positions of reference base stations, a geographic position of said each reference base station being weighted by a coefficient, a value of which is representative of the level of quality of the radio link between said at least one terminal and said each reference base station.

19. The geolocation method of claim 17, wherein the geographic position of the searched base station is further determined according to a measurement carried out for the searched base station of a value representative of a level of quality of a radio link between said at least one terminal and the searched base station.

20. The geolocation method of claim 19, wherein the geographic position of the searched base station is a weighted average of geographic positions of reference base stations, a geographic position of said each reference base station being weighted by a coefficient, the value of which is representative of a difference between the level of quality of the radio link between said at least one terminal and said each reference base station and the level of quality of the radio link between said at least one terminal and the searched base station.

21. The geolocation method of claim 17, wherein the geographic position of the searched base station is determined using a machine learning algorithm according to the measurements carried out and according to the geographic positions of the reference base stations.

22. The geolocation method of claim 16, wherein a group of messages is considered to determine the geographic position of the searched base station, each message being emitted by a terminal of the communication system and received by said at least one reference base station and the searched base station; and wherein for said each message, for the searched base station and for each of the reference base stations having received said each message, a measurement of a value representative of a level of quality of a radio link between a corresponding base station and the terminal emitting said each message is carried out.

23. The geolocation method of claim 22, wherein the geographic position of the searched base station is determined according to an estimate geographic position of the searched base station for said each message of the group.

24. The geolocation method of claim 22, wherein a virtual measurement is calculated for said each reference base station according to the measurements carried out for said at least one reference base station for messages received by said at least one reference base station, and the geographic position of the searched base station is determined according to the virtual measurements and the geographic positions of the reference base stations.

25. The geolocation method of claim 24, wherein the virtual measurement calculated for said at least one reference base station is a weighted average of the measurements carried out for said at least one reference base station for the messages received by said at least one reference base station, each measurement being weighted by a coefficient, the value of which is representative of the measurement of the level of quality of the radio link carried out for the searched base station for a corresponding message.

26. The geolocation method of claim 24, wherein the geographic position of the searched base station is a weighted average of the geographic positions of the reference base stations, each geographic position of a reference base station being weighted by a coefficient, a value of which is representative of the virtual measurement calculated for said reference base station.

27. The geolocation method of claim 22, wherein the geographic position of the searched base station is determined by a regression machine learning algorithm according to the measurements carried out and according to the geographic positions of the reference base stations.

28. A non-transitory computer-readable storage medium comprising a set of program code instructions executable by one or more processors to implement the geolocation method of claim 16.

29. A server of a wireless communication system, the wireless communication system comprising a plurality of base stations and at least one terminal configured to emit messages to the plurality of base stations, the messages emitted by said at least one terminal being simultaneously receivable by the plurality of base stations, the server being connected by a communication link to each base station of said plurality of base stations, the server being configured to implement the geolocation method of claim 16.

30. An access network of a wireless communication system, the access network comprising the plurality of base stations and the server of claim 29.
